(19) United States
(12) Patent Application Publication
(10) Pub. No.: US 2018/0089241 A1
(43) Pub. Date: Mar. 29, 2018

(54) CONTEXT ENHANCED INDEXING

(71) Applicant: Intel Corporation, Santa Clara, CA (US)

(72) Inventors: Omri Mendels, Tel Aviv (IL); Michal Wosk, Tel Aviv (IL)

(21) Appl. No.: 15/279,625

(22) Filed: Sep. 29, 2016

(51) Int. Cl. G06F 17/30; G06F 17/27

(52) U.S. Cl. CPC G06F 17/30312; G06F 17/2705; G06F 17/30864; G06F 17/30011

(57) ABSTRACT

System and techniques for context enhanced indexing are described herein. A document change event may be obtained. A context of the document change event may be captured. Here, the context pertains to an entity responsible for the document change event. Then, an index to correlate a context element of the context to a document of the document change event may be stored.

### TECHNICAL FIELD

Embodiments described herein generally relate to file systems and more specifically to context enhanced indexing.

### BACKGROUND

File systems and other document storage systems store data and provide mechanisms to locate and retrieve that data. Often, file systems are hierarchical, storing data in directories (e.g., folders) that user's define. Locating these files generally involves careful planning in storing the files and later remembering the organizational structure originally designed to retrieve those files. For example, storing recipes from a grandparent in a directory for the grandparent that is contained in a recipes directory.

The inflexible nature of older file system organizational designs has led to an increase in maintaining an index for these files to accommodate searching by the user. Generally, the files themselves will be stored with some metadata, such as a user identification (ID) who created or modified the file, a modification timestamp, file type, or the like. Indexing may include scanning stored files to find this metadata and store it in an efficient lookup data structure, such as a binary search tree, heap, B-tree, or the like. The index may also include keywords extracted from the file contents during the scan.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an example of an environment including a system for context enhanced indexing, according to an embodiment.

FIG. 2 illustrates and example of a component and communication flow for context enhanced indexing, according to an embodiment.

FIG. 3 illustrates an example of a method for context enhanced indexing, according to an embodiment.

FIG. 4 illustrates an example of a method for context enhanced indexing, according to an embodiment.

FIG. 5 is a block diagram illustrating an example of a machine upon which one or more embodiments may be implemented.

### DETAILED DESCRIPTION

Existing search techniques applied to files (e.g., documents, messages, photos, media files, etc.) generally rely on creation or modification meta data, keyword detection, or tagging. Here, tagging refers to an explicitly added piece of metadata, generally made by the user. An example may include a user marking a particular file as important. These techniques generally perform poorly in a number of scenarios. For example, these techniques provide false positive results (e.g., find files that are not of interest to the searching user). That is, keyword searches will generally return all files that contain the keyword. This may lead to numerous irrelevant results that the user must manually review and discard.

Traditional searching techniques also make trade-offs in which files are indexed, leading to a number of files essentially being inaccessible via the traditional searching mechanisms. For example, current platforms (e.g., devices, operating systems, applications, etc.) create many files these may be created explicitly by the users or automatically by the systems such as temporary files, deleted files, log files, among others. Generally, these files are inaccessible to users because they are not indexed, labeled, created by the user directly (e.g., the modification ID is a software account rather than a user account), etc. Further, some search engines purposefully reject these types of files in an attempt to reduce false positive results.

For keyword focused indexing, missing keywords may lead to ineffective searching. Some files are not saved with the keywords that users will expect to use while searching, either due to use of a synonym, abbreviation, etc. For example, an article about “Gross Domestic Product” will not likely be found if the user searches for the common abbreviation “GDP” unless the acronym itself appears in the article. Similarly, some files are given automatic names that do not contain an expected keyword, and thus a keyword-based search will not find them. For example, many mobile phones and cameras give photograph files a serial number as their name. Thus, if the user searches for a “birthday cake” photo, a keyword search is unlikely to find the photograph.

Additionally, traditional indexed searches often involve complex or manual indexing to improve search results (e.g., both accuracy and speed). That is, in order for current search techniques to return relevant results in minimal search time, quality indexing algorithms or mechanisms are applied. These efforts often involve significant computing resources (e.g., hardware, time, or power) and very often impose a burden on users to accurately label files. These activities are inefficient, time consuming, and generally do not scale well.

Existing techniques fail, however, to incorporate characteristics of the audience in improving indexes searched by humans. People often don't remember files according to keywords or tags that may have seemed relevant at the time. Instead people remember associations and context about when, where, and what was the state of the user while creating, receiving, sending, updating or any interaction with the file. What is needed are systems or techniques for searching a file of any type (email, document, photo, message, etc.) according to the user context when interacting with the file. Existing searches (e.g., keyword, manual tagging, meta data, etc.) will be replaced or complemented by a contextual search such as: “The photo I took when I was driving to Santa Clara,” “The document I sent Mike when I met Sally at work,” “The emails I read after the team status meeting,” or the like.

Existing user platforms (e.g., devices, operating systems, apps, etc.) have broad knowledge about user states. The following is a non-exhaustive list of user states generally obtainable from user devices (e.g., phone, wearables, workstation, etc.) or services (e.g., email, calendaring, messaging, etc.) or derivable from other user states (e.g., rich contexts or intents):
Where the user is. This location may be precise (e.g., latitude and longitude such as from a satellite position system), at an address level (e.g., a street address), at a higher political entity level (e.g., what city, county, province, state, country, continent, etc.), at a point-of-interest (POI) level (e.g., Starbucks on the 5th, Marriott Santa Clara), or at a high semantic level (e.g., home, work, Mom's house, etc.)
What the user is doing (e.g., resting, sleeping, running, driving, eating, etc.)
What event (e.g., meeting or other interaction such as a party, concert, etc.) is the user currently attending.
What the user's position in time or space with respect to an interaction is. For example, is the user early, late, near, or far away from an interaction (e.g., meeting)?
What activity the user is engaged in, such as phone calls, text messages, editing an image, etc. In an example, the activity is that measurable by a device or service of the user, for example, by noting what application is running on a device at a particular time.
What the user is using to travel, such as by foot, by car, by bus, by train, by plane, by boat, etc.
Who is expected to, or did, participate in an interaction or a context of the interaction, such as a calendar meeting, the other participants that that accepted an invitation to the meeting, the location of the meeting, or the subject of the meeting.
Derivatives of the above, correlated in time, to produce additional context to satisfy user queries such as the following:
   In a meeting with Dan at the Hilton.
   Arriving to work ten minutes before the team meeting.
   Around lunchtime.
   Right after I woke up.
   When I was on the bus headed to San Francisco.
   When I was out of office last week.
   Following a meeting about “SoC Strategy.”
   When my phone battery drained.

As noted above, the context may be a combination of user state and user intent. User state includes such things that may be immediately ascertained, such as a time of day, a user appointment on a calendar, etc. Intents include an inference as to what a user was doing. For example, user state may include a measurement that the user is in a vehicle and traveling north while the user's calendar includes an appointment at a location with a person named John. The intent is inferred from the state to be that the “user is driving to meet John.” This information may be collected and incorporated into file indexes to allow users a natural technique by which to associate a file with events in the users' lives.

To support context enhanced indexing, user activities are tracked and recorded to maintain a user state database. When a user searches for content, the state database is used to identify relevant data. In an example, context elements may be added to files as smart tags, either at file modification (e.g., creation, change, deletion, etc.), when a user state change occurred, or during a periodic offline (e.g., batch) process of the context. The search engine may organize search query results by way of the smart tags. For example, given an audio file of a voice message received while the user is driving to meet his daughter, the user may proffer the query, “who left me a message when I was on the way to meet John?” The search engine may parse the natural language query and use the user state database to ascertain a period in which a message (e.g., audio, text, etc.) was created while the user was traveling to meet John. When the smart tags are attached (e.g., placed in file meta data or indexed in a database with a reference to the file) at file creation, the search engine may search for message files that have the tags corresponding to being in a vehicle (e.g., state tag: in vehicle, state tag: driving), a message (e.g., file type tag: audio), and to “meet john,” (e.g., intent tag: meeting [John]). In an example, where the smart tags are not attached at file creation, the search engine may intersect time periods for states corresponding to the above and the filter a message file search to exclude found files that are not within the intersection.

Using file interaction context indexing allows users to perform an intuitive search that assimilates the information retrieval cognitive process of human minds. In other words, context enhanced indexing permits people to use their natural associative powers to find documents. Additional details and embodiments are described below.

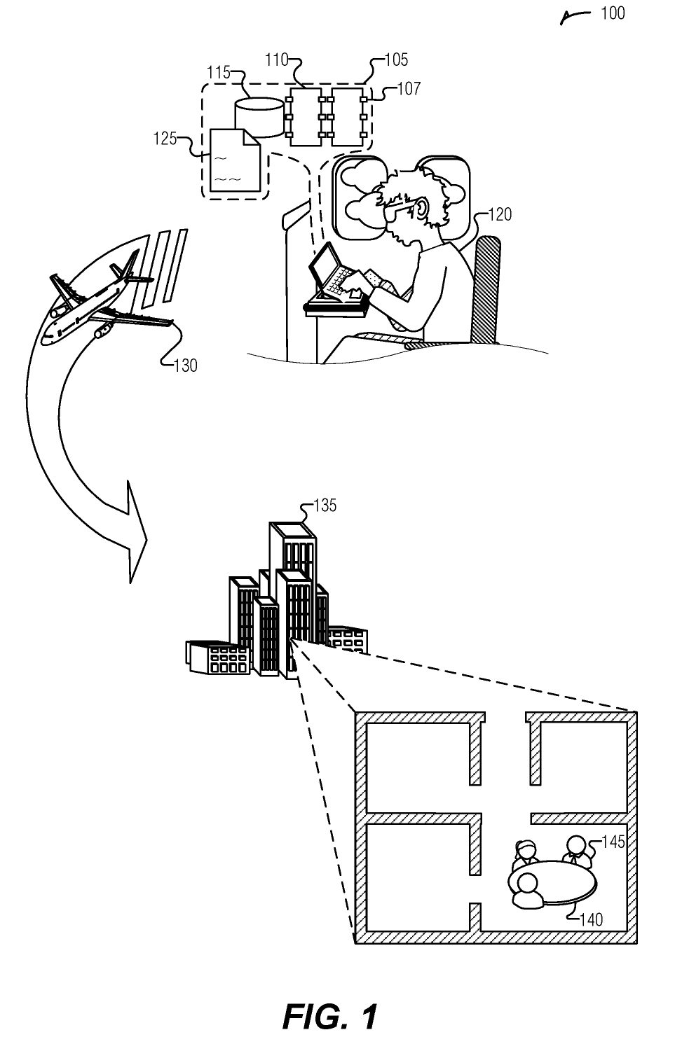

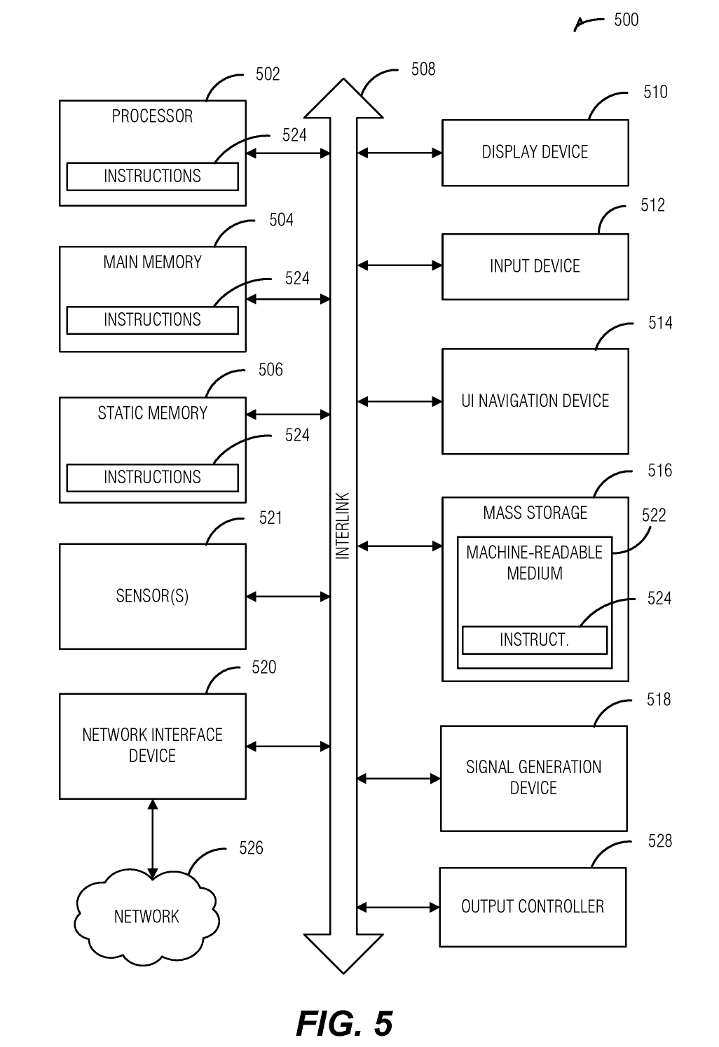

FIG. 1 is an example of an environment 100 including a system 105 for context enhanced indexing, according to an embodiment. The system 105 includes an event listener 107, a sensor 110, and a data store 115. These elements are implemented in computer hardware such as that described below with respect to FIG. 5. The environment 100 illustrates the user 120 traveling in a plane 130 to a city 135 for a meeting 140 with Liam 145. These elements, as described below, provide the context for the modification to the file 125 that the user 120 is working on during the flight.

The event listener 107 is arranged to obtain a document change event. The document change event is a notification that the document 125 has an undergone a change, such as being accessed (e.g., read), written to, created, deleted, or had its meta data modified. In an example, the document change event is generated by a file system storing the document 125. In an example, the document change event is generated by a monitoring process that periodically scans the file system and compares metrics from a previous scan to a current scan to determine whether the document 125 has been changed. In an example, the document change event includes a timestamp of when the modification occurred. In an example, the document change event includes an identification of the document 125, such as a name, serial number, file system path, etc. The document identification may be omitted, however, in examples where time windows are used to filter searches based on the context. In these examples, the context at a particular time is captured, since files are often already indexed based on time, storage or other resources may be conserved by omitting the document identification. In an example, the document change event includes a type. In an example, the type is one of create, modify, modify-content, modify-meta-data, access, or delete.

The sensor 110 is arranged to capture the context of the document change event. The sensor 110 either includes an environment sensor (e.g., a satellite positioning system for location, an accelerometer to determine that the user 120 is moving, sleeping, etc.), or an interface to a device with such metrics when in operation. The sensor 110, thus, records context elements (e.g., individual readings) itself, receives them from one or more other devices, or reaches out to obtain them from the one or more other devices. Thus, in an example, to capture the context of the document change event, the sensor 110 is arranged to query a context item provider. Again, the context item provider is a device, application or service that may provide the context item. In an example, the query of the context item provider is performed in response to receiving the document change event. In an example, to capture the context of the document change event, the sensor 110 is to store the context item in an entity state data structure. The entity state data structure includes the context item (or a derived representation thereof) and a timestamp.

As noted above, the context pertains to an entity (e.g., user 120) responsible for the document change event. In an example, the entity may be a business, or simply an account identification. The expansion of the entity to be more than simply a person may permit, for example, a system administrator to make a request during a period in which a system account (e.g., not a human account) was performing a task.

In an example, the context includes at least one context item from a set of context items. Here, the set of context items are a predetermined list of metrics that the sensor 110 will obtain. Thus, although a wearable device may both report a sleeping period for the user 120 as well as a heart rate, the heart rate may not be in the set of context items and thus not obtained by the sensor 110. In this manner, elements of context determined to be pertinent to searches may be tuned. In an example, the context item has a context category from a plurality of context categories. Context categories may be used to ensure that particular data is collected but, once being collected, redundant data is not obtained. For example, if the context category is location and a street address is obtained, additional location data, such as the continent of the location, may be omitted. In an example, the context category is entity location. This is the location of the entity (e.g., user 120) itself. In this example, the context item is at least one of at a location, near the location, or traveling relative to the location. Thus, if the city 135 is New York, the context item may be that user 120 is traveling to New York 135 and is near the city 135.

In an example, the context category is location type. In this example, the context item is at least one of a geographical coordinate (e.g., latitude and longitude), an address (e.g., a street or postal address), a place type (e.g., city, park, plaza, shopping district, building, etc.), a point-of-interest (POI), an environmental feature (e.g., river, mountain, hill, valley, forest, lake, bay, etc.), an area (e.g., downtown, metro-area, tristate area, etc.) or relative to an entity anchor place (e.g., at home, away from home, out of the country, at work, at school, at parent's house, etc.).

In an example, the context category is entity transit. In this example, the context item is at least one of traveling to a target (e.g., heading home, etc.), traveling away from a target (e.g., leaving POI), target arrival status (e.g., near to school, late to meeting, etc.), mode of transit (e.g., driving, flying, riding on buss, traveling under own power, such as walking, in a wheelchair, etc.).

In an example, the context category is entity time classification. In this example, the context item is at least one of a local time (e.g., with daylight savings or offset from Greenwich Mean Time (GMT) applied, etc.), a part of day (e.g., morning, midday, evening, night, early morning, middle of the night, etc.), a day of week (e.g., weekend, Monday, etc.), or special days (e.g., birthday, relative's anniversary, holiday, sporting event day, etc.). The specialness of the days may be based on the user 120 entering these days into a calendar, or derived from a group to which the user 120 belongs, such as a religion, country, etc.

In an example, the context category is inter-entity interaction. inter-entity interaction is an activity between the entity (e.g., user 120) and another entity, such as Liam 145 in the meeting 140, a job interview at a company, a party for the user 120 in which his partner will attend, etc. In an example, the context item is at least one of a meeting or a teleconference. Other inter-entity interactions may include such things as a party, concert, or other events in which the user 120 and another participant, such as Liam 145, is identifiable.

In an example, the context category is entity action. In this example, the context item is at least one of using a device or using an application on a device. Thus, the question, “what document was I editing when listening to Christmas carols” may be answered as both the editing and the listening are entity actions derivable from the applications and devices being used by the user 120, for example.

In an example, the plurality of context categories include at least two of entity location, location type, entity transit, entity time classification, inter-entity interaction, or entity action. In an example, traveling relative to the location includes at least one of approaching the location or receding from the location.

The data store 115 is arranged to store an index to correlate a context element of the context to the document 125 of the document change event. In an example, to store the context item in the entity state data structure, the data store 115 is arranged to log context item provider responses to the query. In an example, to log the context item, the data store 115 is arranged to store a log entry that includes an entity identification, a timestamp, and an activity. In an example, to store the context item in the entity data structure, the data store 115 is arranged to create a tag for the document including the entity state data structure. In an example, the tag is the index.

In an example, the data store 115 is arranged to aggregate the responses (from the context item provider queries) to produce a state window and to store a state with the state window. Thus, several responses may be combined to establish a start time and end time for an intent. For example, a calendar entry for the meeting 140 in a city 135 different than where the user 120 is currently is a first response, several altimeter readings indicating that the user 120 is on the surface of the earth, then several thousand feet above the earth, then back at the surface level of the earth, and then a satellite positioning reading indicating that the user 120 is near to the city 135, are all individual response with individual timestamps. However, aggregating these responses results in a departure time—e.g., the last altimeter reading at the surface before a non-surface altimeter reading—and an arrival time—an average between the timestamps of the next altimeter reading at the earth's surface and the satellite positioning reading. These two times define the boundaries of the window in which the user 125 is flying (e.g., inferred by not being at the earth's surface, the speed of travel, the calendar, etc.) towards the meeting 140. In an example, the aggregation is performed in real-time. In an example, the aggregation is performed periodically in an offline, or batch, fashion. In an example, the state window includes an aggregated result from logging a response from a second context item provider for a second context category.

The system 105 may be extended to include a search engine. The search engine is arranged to receive a context query for the document. As noted above, such a context query may be natural language (e.g., “what was I reading before bedtime two nights ago”) or otherwise use context categories (e.g., “search: item->‘article’; time->‘before bedtime’; time->‘-two nights’; activity->‘reading’” or the like).

The search engine is arranged to parse the context query to obtain an index element. Here, the index element may include one or more times or time windows or it may include a context item stored in the index. In an example, the search engine is arranged to obtain a context category definition, scan the context query for an element satisfying the context category definition, and create the index element from each item found during the scanning. Thus, the context category provides the context items that are permissible and a definition (e.g., a regular expression, look up table, parser, etc.) to identifies a context element for the context category. The definition is used by the search engine to identify which context element are called out in the query. Once these elements are identified, an intersection of the elements provides the index. In an example, the index element is a window corresponding to an entity state matching each item found during the scanning.

The search engine is arranged to locate the document via the index using the index element. For example, if the index is a window, the search engine identifies files that match the context query with a modification event time within the window. Thus, in an example, the search engine is arranged to search for documents with a modification timestamp within the window, and return results of the searching. In another example, if the index element is a set of tags, the search engine searches for a file with at least the same tags derived from the context query.

Using entity context to enhance file search indexes leverages existing data about the entity to provide an intuitive search experience that reduces false positives and releases users from having to manually manage tags, hierarchies, or the like. Such a search may be added onto traditional file searches or may supplant them entirely.

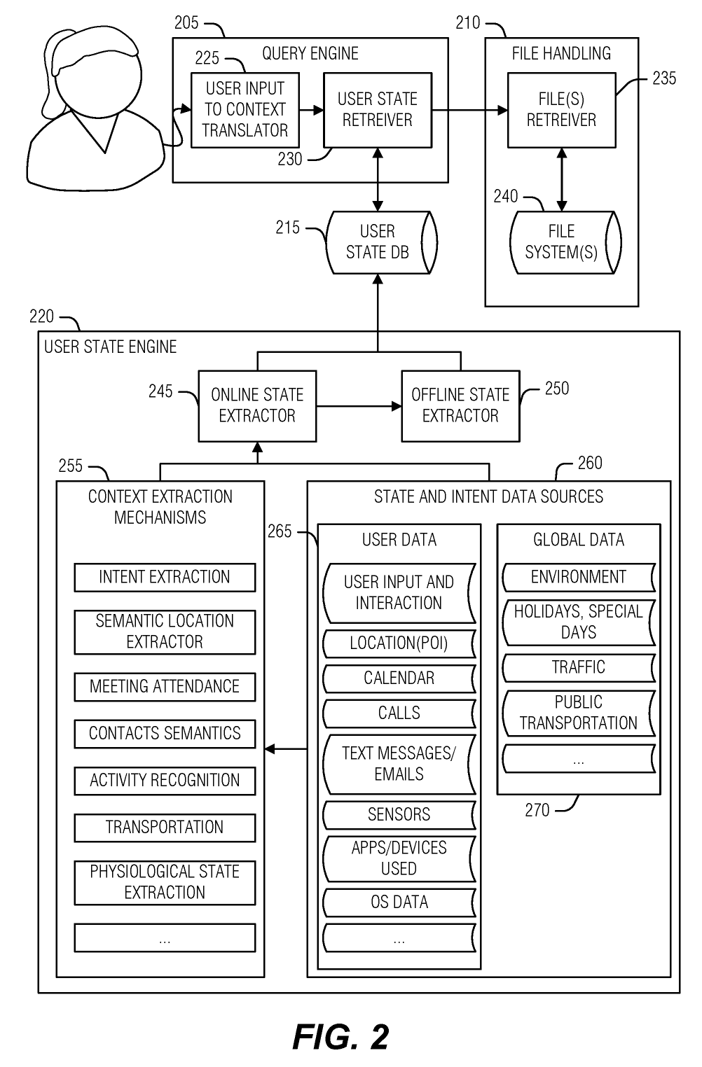

FIG. 2 illustrates and example of a component and communication flow for context enhanced indexing, according to an embodiment. The illustrated components, aside from the user, are implemented in computer hardware such as that described below with respect to FIG. 5 (e.g., circuits). The components of FIG. 2 provide an alternative arrangement of the functions and elements described above with respect to FIG. 1.

The user state engine 220 is arranged to continuously analyze the user state by fusing a plurality of data sources 260, which may include personal data 265, global data 270, combinations of both, or derivations of either or both via context extraction mechanisms 255. The user state may include contextual information such as temporal data, spatial user data (e.g., location, activity, availability, data about meetings), user actions or behavior, or interactions with other individuals. The user state may also include global data, such as environment (e.g. weather, air quality), special days (e.g., holidays, elections), traffic, or public transportation data.

The user state engine 220 extracts the user's state at a given time in two phases. In the first phase, a current state is extracted (operation 245). In a second phase, an offline process (operation 250) occurs, deriving a more comprehensive and semantic-rich state from previously collected current states. The following are examples of this activity:
1. The online process identifies that the user is driving and marks it as state A: {user=<id>, time=<timestamp1>, activity=driving}
2. The online process identifies that the user arrives to work and marks it as state B. {user=<id>, time=<timestamp2>, location=work}
3. Based on state B, the offline process adds another attribute to state A: {user=<id>, time=<timestamp1>, activity=driving, destination=work} (the destination “work” was added to (1) via (2) to produce this record (3).

Extracted states are kept in the user state database 215 along with relevant state entities and a timeframe (e.g., window or time window) in which the state was true. The following are a number of example states organized by state categories:

Place States:
At place X
Arriving/approaching/nearby/to place X
Before/After leaving place X
Driving from/driving to

Place Types:
Specific place type (e.g., At a restaurant/shoe shop)
Specific business (e.g., Starbucks Broadway and 75th St.)
Specific public place (e.g., At the beach/park/forest/desert)
Area (e.g., In Europe/in Germany/in Munich/in central Munich)
On vacation
On a business trip
Abroad
Arrive/leave/approach/nearby to place type

Transportation States:
On my way to place X
On my way from place X
When approaching to place X
While driving/walking/running/cycling . . .
While driving/walking/running/cycling . . . to place/near place/approach place
While on bus/train/subway
While on bus/train/subway . . . to place/near place/approach place
While on bus 515
Late to place X

Time States:
Specific time (e.g., at 8:00)
Part of day (e.g., In the morning)
Day of week
Weekend/weekday
Holidays
Special days

Meeting States:
In a meeting
In a meeting at
In a meeting with
In a meeting about
Before/after the meeting . . . (e.g., at, with, about)
On my way to the meeting . . . (e.g., at, with, about)
When I was late to the meeting . . . (e.g., at, with, about)
On the phone with
While waiting to meet . . .
During {meeting subject} (e.g., During George's birthday)
While meeting (e.g., no explicit meeting in calendar, based on proximity of devices or person recognition)

Action States:
While using my PC
While using app X

These states may be combined in any way. Examples of combining states may include:
On my way to home on the A train
When I was in Germany on a business trip meeting Freddy
When I arrived late to work on Monday
Before arriving home on new year's evening

The query engine 205 retrieves files based on a requested state. The query engine 205 translates the user input—which may come in a form of voice, text, graphical user interface (GUI), among others—for selecting the relevant state or state keyword search (operation 225). An example result of the translation may include: Monday morning+bus+on the way to work. Once the state entities are extracted, the query engine 205 retrieves the time frames of the state from the user state database 215 (operation 230). Both the full state and subsets of the state may be used for file lookup (e.g., via the file handling component 210). The user state retrieval 230 interfaces with the files via a file retriever 235 with access to the file system 240 storing the file. For example, if the user looked for “In a meeting with Dan at the Hilton,” the query engine 205 may propose files that were interacted with by the user while meeting with Dan at the Hilton. In an example, the query engine 205 is arranged to accept keywords from the user or file types from the user to further filter results. For example, the query “the monthly report document that I read on the train on the way to work” specifies context elements as well as a keyword “monthly report.”

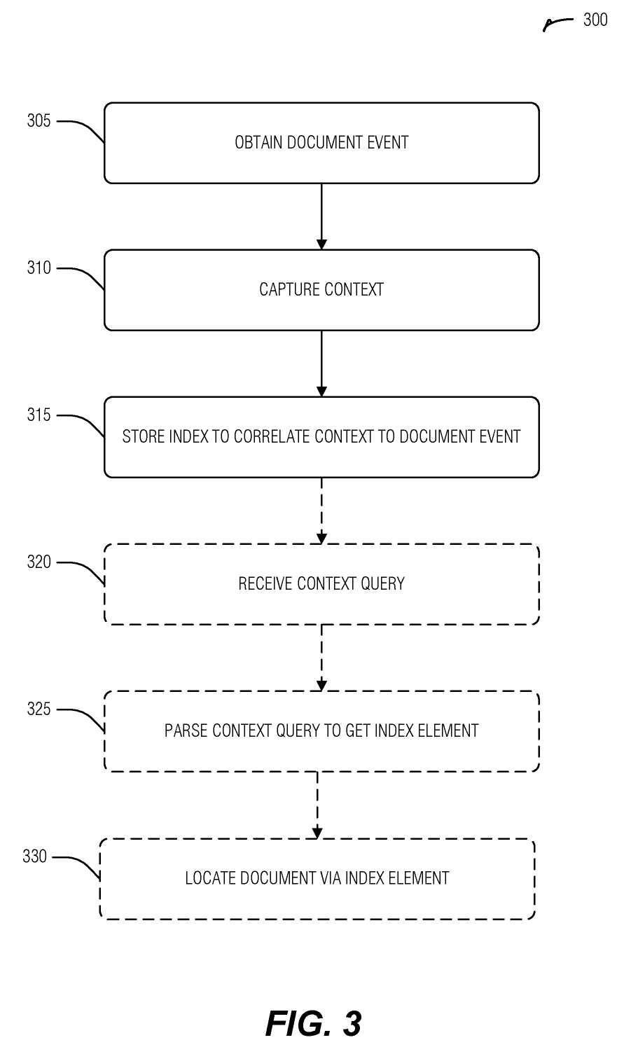

FIG. 3 illustrates an example of a method 300 for context enhanced indexing, according to an embodiment. The operations of the method 300 are performed with computer hardware, such as that described above and below (e.g., circuits).

At operation 305, a document change event is obtained.

At operation 310, a context of the document change event is captured. In an example, the context pertains to an entity responsible for the document change event. In an example, wherein context includes at least one context item from a set of context items. In an example, the context item has a context category from a plurality of context categories.

In an example, the context category is entity location, and wherein the context item is at least one of at a location, near the location, or traveling relative to the location. In an example, the plurality of context categories include at least two of entity location, location type, entity transit, entity time classification, inter-entity interaction, or entity action. In an example, traveling relative to the location includes at least one of approaching the location or receding from the location. In an example, the context category is location type, and wherein the context item is at least one of a geographical coordinate, an address, a place type, a POI, an environmental feature, an area, or relative to an entity anchor place. In an example, the context category is entity transit, and wherein the context item is at least one of traveling to a target, traveling away from a target, target arrival status, mode of transit. In an example, the context category is entity time classification, and wherein the context item is at least one of a local time, a part of day, a day of week, special days. In an example, the context category is inter-entity interaction, and wherein the context item is at least one of a meeting or a teleconference. In an example, wherein the context category is entity action, and wherein the context item is at least one of using a device or using an application on a device.

In an example, capturing the context of the document change event includes querying a context item provider, and storing the context item in an entity state data structure. In an example, querying the context item provider is performed in response to receiving the document change event. In an example, storing the context item in the entity data structure includes creating a tag for the document including the entity state data structure, the tag being the index.

In an example, storing the context item in the entity state data structure includes logging context item provider responses to the query, aggregating the responses to produce a state window, and storing a state with the state window. In an example, logging the context item includes storing a log entry that includes an entity identification, a timestamp, and an activity. In an example, the state window includes an aggregated result from logging a response from a second context item provider for a second context category.

At operation 315, an index to correlate a context element of the context to a document of the document change event is stored.

At optional operation 320, a context query for the document is received.

At optional operation 325, the context query is parsed to obtain an index element. In an example, parsing the context query includes obtaining a context category definition, scanning the context query for an element satisfying the context category definition, and creating the index element from each item found during the scanning. In an example, the index element is a window corresponding to an entity state matching each item found during the scanning. In an example, locating the document via the index using the index element includes searching for documents with a modification timestamp within the window, and returning results of the searching.

At optional operation 330, the document is located via the index using the index element.

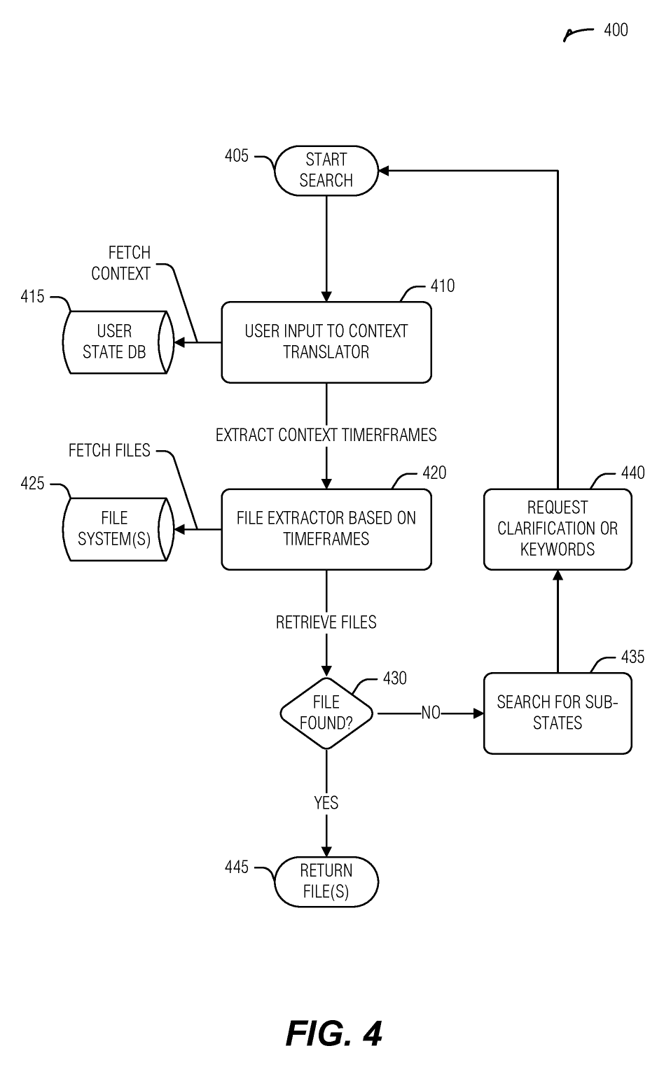

FIG. 4 illustrates an example of a method 400 for context enhanced indexing, according to an embodiment. The operations of the method 400 are performed with computer hardware, such as that described above and below (e.g., circuits).

The method 400 begins by offering an interface to receive the context based query for a file from the user (operation 405). The interface may be a GUI permitting text input, selecting from category and providing a value (e.g., user selects “relative time” and enters “last night”), a voice interface, or the like. After the user input is received it is translated into the context format compatible with the context storage in the user state database 415, and then the context is fetched (operation 410). After the context is fetched, context elements are processed to extract context timeframes (e.g., windows) to enhance the context. The timeframes are then used to fetch one or more files from one or more file systems 425 (operation 420).

The fetched files are tested to determine whether the desired file is included in their number (operation 430). The determination of the specific file may include additional elements entered into the user interface, such as keywords, file types, originating application, etc. If the files are found, they are presented to the user as search results and the method 400 ends (operation 445). If the files are not found, the method 400 identifies sub-states from those already identified by the user (operation 435) and requests clarification from the user (e.g., by suggesting the sub-states or keywords derived therefrom) (operation 440), returning to the user interface (operation 405), modifying the interface to include the clarification request.

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### ADDITIONAL NOTES & EXAMPLES

Example 1 is a system for context enhanced indexing, the system comprising: an event listener to obtain a document change event; a sensor to capture a context of the document change event, the context pertaining to an entity responsible for the document change event; and a data store to store an index to correlate a context element of the context to a document of the document change event.

In Example 2, the subject matter of Example 1 optionally includes wherein the context includes at least one context item from a set of context items.

In Example 3, the subject matter of Example 2 optionally includes wherein the context item has a context category from a plurality of context categories.

In Example 4, the subject matter of Example 3 optionally includes wherein the context category is entity location, and wherein the context item is at least one of at a location, near the location, or traveling relative to the location.

In Example 5, the subject matter of Example 4 optionally includes wherein traveling relative to the location includes at least one of approaching the location or receding from the location.

In Example 6, the subject matter of any one or more of Examples 3-5 optionally include wherein the context category is location type, and wherein the context item is at least one of a geographical coordinate, an address, a place type, a point-of-interest (POI), an environmental feature, an area, or relative to an entity anchor place.

In Example 7, the subject matter of any one or more of Examples 3-6 optionally include wherein the context category is entity transit, and wherein the context item is at least one of traveling to a target, traveling away from a target, target arrival status, mode of transit.

In Example 8, the subject matter of any one or more of Examples 3-7 optionally include wherein the context category is entity time classification, and wherein the context item is at least one of a local time, a part of day, a day of week, or special days.

In Example 9, the subject matter of any one or more of Examples 3-8 optionally include wherein the context category is inter-entity interaction, and wherein the context item is at least one of a meeting or a teleconference.

In Example 10, the subject matter of any one or more of Examples 3-9 optionally include wherein the context category is entity action, and wherein the context item is at least one of using a device or using an application on a device.

In Example 11, the subject matter of any one or more of Examples 3-10 optionally include wherein the plurality of context categories include at least two of entity location, location type, entity transit, entity time classification, inter-entity interaction, or entity action.

In Example 12, the subject matter of any one or more of Examples 1-11 optionally include wherein, to capture the context of the document change event, the sensor is to: query a context item provider; and store the context item in an entity state data structure.

In Example 13, the subject matter of Example 12 optionally includes wherein, to store the context item in the entity state data structure, the data store is to: log context item provider responses to the query; aggregate the responses to produce a state window; and store a state with the state window.

In Example 14, the subject matter of Example 13 optionally includes wherein, to log the context item, the data store is to store a log entry that includes an entity identification, a timestamp, and an activity.

In Example 15, the subject matter of any one or more of Examples 13-14 optionally include wherein the state window includes an aggregated result from logging a response from a second context item provider for a second context category.

In Example 16, the subject matter of any one or more of Examples 12-15 optionally include wherein the query of the context item provider is performed in response to receiving the document change event.

In Example 17, the subject matter of Example 16 optionally includes wherein, to store the context item in the entity data structure, the data store is to create a tag for the document including the entity state data structure, the tag being the index.

In Example 18, the subject matter of any one or more of Examples 1-17 optionally include a search engine to: receive a context query for the document; parse the context query to obtain an index element; and locate the document via the index using the index element.

In Example 19, the subject matter of Example 18 optionally includes wherein, to parse the context query, the search engine is to: obtain a context category definition; scan the context query for an element satisfying the context category definition; and create the index element from each item found during the scanning.

In Example 20, the subject matter of Example 19 optionally includes wherein the index element is a window corresponding to an entity state matching each item found during the scanning.

In Example 21, the subject matter of Example 20 optionally includes wherein, to locate the document via the index using the index element, the search engine is to: search for documents with a modification timestamp within the window; and return results of the searching.

Example 22 is a method for context enhanced indexing, the method comprising: obtaining a document change event; capturing a context of the document change event, the context pertaining to an entity responsible for the document change event; and storing an index to correlate a context element of the context to a document of the document change event.

In Example 23, the subject matter of Example 22 optionally includes wherein the context includes at least one context item from a set of context items.

In Example 24, the subject matter of Example 23 optionally includes wherein the context item has a context category from a plurality of context categories.

In Example 25, the subject matter of Example 24 optionally includes wherein the context category is entity location, and wherein the context item is at least one of at a location, near the location, or traveling relative to the location.

In Example 26, the subject matter of Example 25 optionally includes wherein traveling relative to the location includes at least one of approaching the location or receding from the location.

In Example 27, the subject matter of any one or more of Examples 24-26 optionally include wherein the context category is location type, and wherein the context item is at least one of a geographical coordinate, an address, a place type, a point-of-interest (POI), an environmental feature, an area, or relative to an entity anchor place.

In Example 28, the subject matter of any one or more of Examples 24-27 optionally include wherein the context category is entity transit, and wherein the context item is at least one of traveling to a target, traveling away from a target, target arrival status, mode of transit.

In Example 29, the subject matter of any one or more of Examples 24-28 optionally include wherein the context category is entity time classification, and wherein the context item is at least one of a local time, a part of day, a day of week, or special days.

In Example 30, the subject matter of any one or more of Examples 24-29 optionally include wherein the context category is inter-entity interaction, and wherein the context item is at least one of a meeting or a teleconference.

In Example 31, the subject matter of any one or more of Examples 24-30 optionally include wherein the context category is entity action, and wherein the context item is at least one of using a device or using an application on a device.

In Example 32, the subject matter of any one or more of Examples 24-31 optionally include wherein the plurality of context categories include at least two of entity location, location type, entity transit, entity time classification, inter-entity interaction, or entity action.

In Example 33, the subject matter of any one or more of Examples 22-32 optionally include wherein capturing the context of the document change event includes: querying a context item provider; and storing the context item in an entity state data structure.

In Example 34, the subject matter of Example 33 optionally includes wherein storing the context item in the entity state data structure includes: logging context item provider responses to the query; aggregating the responses to produce a state window; and storing a state with the state window.

In Example 35, the subject matter of Example 34 optionally includes wherein logging the context item includes storing a log entry that includes an entity identification, a timestamp, and an activity.

In Example 36, the subject matter of any one or more of Examples 34-35 optionally include wherein the state window includes an aggregated result from logging a response from a second context item provider for a second context category.

In Example 37, the subject matter of any one or more of Examples 33-36 optionally include wherein querying the context item provider is performed in response to receiving the document change event.

In Example 38, the subject matter of Example 37 optionally includes wherein storing the context item in the entity data structure includes creating a tag for the document including the entity state data structure, the tag being the index.

In Example 39, the subject matter of any one or more of Examples 22-38 optionally include receiving a context query for the document; parsing the context query to obtain an index element; and locating the document via the index using the index element.

In Example 40, the subject matter of Example 39 optionally includes wherein parsing the context query includes: obtaining a context category definition; scanning the context query for an element satisfying the context category definition; and creating the index element from each item found during the scanning.

In Example 41, the subject matter of Example 40 optionally includes wherein the index element is a window corresponding to an entity state matching each item found during the scanning.

In Example 42, the subject matter of Example 41 optionally includes wherein locating the document via the index using the index element includes: searching for documents with a modification timestamp within the window; and returning results of the searching.

Example 43 is at least one machine readable medium including instructions that, when executed by a machine, cause the machine to perform any method of Examples 22-42.

Example 44 is a system comprising means to perform any method of Examples 22-42.

Example 45 is a system for context enhanced indexing, the system comprising: means for obtaining a document change event; means for capturing a context of the document change event, the context pertaining to an entity responsible for the document change event; and means for storing an index to correlate a context element of the context to a document of the document change event.

In Example 46, the subject matter of Example 45 optionally includes wherein the context includes at least one context item from a set of context items.

In Example 47, the subject matter of Example 46 optionally includes wherein the context item has a context category from a plurality of context categories.

In Example 48, the subject matter of Example 47 optionally includes wherein the context category is entity location, and wherein the context item is at least one of at a location, near the location, or traveling relative to the location.

In Example 49, the subject matter of Example 48 optionally includes wherein traveling relative to the location includes at least one of approaching the location or receding from the location.

In Example 50, the subject matter of any one or more of Examples 47-49 optionally include wherein the context category is location type, and wherein the context item is at least one of a geographical coordinate, an address, a place type, a point-of-interest (POI), an environmental feature, an area, or relative to an entity anchor place.

In Example 51, the subject matter of any one or more of Examples 47-50 optionally include wherein the context category is entity transit, and wherein the context item is at least one of traveling to a target, traveling away from a target, target arrival status, mode of transit.

In Example 52, the subject matter of any one or more of Examples 47-51 optionally include wherein the context category is entity time classification, and wherein the context item is at least one of a local time, a part of day, a day of week, or special days.

In Example 53, the subject matter of any one or more of Examples 47-52 optionally include wherein the context category is inter-entity interaction, and wherein the context item is at least one of a meeting or a teleconference.

In Example 54, the subject matter of any one or more of Examples 47-53 optionally include wherein the context category is entity action, and wherein the context item is at least one of using a device or using an application on a device.

In Example 55, the subject matter of any one or more of Examples 47-54 optionally include wherein the plurality of context categories include at least two of entity location, location type, entity transit, entity time classification, inter-entity interaction, or entity action.

In Example 56, the subject matter of any one or more of Examples 45-55 optionally include wherein the means for capturing the context of the document change event includes: means for querying a context item provider; and means for storing the context item in an entity state data structure.

In Example 57, the subject matter of Example 56 optionally includes wherein the means for storing the context item in the entity state data structure includes: means for logging context item provider responses to the query; means for aggregating the responses to produce a state window; and means for storing a state with the state window.

In Example 58, the subject matter of Example 57 optionally includes wherein the means for logging the context item includes means for storing a log entry that includes an entity identification, a timestamp, and an activity.

In Example 59, the subject matter of any one or more of Examples 57-58 optionally include wherein the state window includes an aggregated result from logging a response from a second context item provider for a second context category.

In Example 60, the subject matter of any one or more of Examples 56-59 optionally include wherein querying the context item provider is performed in response to receiving the document change event.

In Example 61, the subject matter of Example 60 optionally includes wherein the means for storing the context item in the entity data structure includes means for creating a tag for the document including the entity state data structure, the tag being the index.

In Example 62, the subject matter of any one or more of Examples 45-61 optionally include means for receiving a context query for the document; means for parsing the context query to obtain an index element; and means for locating the document via the index using the index element.

In Example 63, the subject matter of Example 62 optionally includes wherein the means for parsing the context query includes: means for obtaining a context category definition; means for scanning the context query for an element satisfying the context category definition; and means for creating the index element from each item found during the scanning.

In Example 64, the subject matter of Example 63 optionally includes wherein the index element is a window corresponding to an entity state matching each item found during the scanning.

In Example 65, the subject matter of Example 64 optionally includes wherein the means for locating the document via the index using the index element includes: means for searching for documents with a modification timestamp within the window; and means for returning results of the searching.

Example 66 is at least one machine readable medium including instructions for context enhanced indexing, the instructions, when executed by a machine, cause the machine to perform operations comprising: obtaining a document change event; capturing a context of the document change event, the context pertaining to an entity responsible for the document change event; and storing an index to correlate a context element of the context to a document of the document change event.

In Example 67, the subject matter of Example 66 optionally includes wherein the context includes at least one context item from a set of context items.

In Example 68, the subject matter of Example 67 optionally includes wherein the context item has a context category from a plurality of context categories.

In Example 69, the subject matter of Example 68 optionally includes wherein the context category is entity location, and wherein the context item is at least one of at a location, near the location, or traveling relative to the location.

In Example 70, the subject matter of Example 69 optionally includes wherein traveling relative to the location includes at least one of approaching the location or receding from the location.

In Example 71, the subject matter of any one or more of Examples 68-70 optionally include wherein the context category is location type, and wherein the context item is at least one of a geographical coordinate, an address, a place type, a point-of-interest (POI), an environmental feature, an area, or relative to an entity anchor place.

In Example 72, the subject matter of any one or more of Examples 68-71 optionally include wherein the context category is entity transit, and wherein the context item is at least one of traveling to a target, traveling away from a target, target arrival status, mode of transit.

In Example 73, the subject matter of any one or more of Examples 68-72 optionally include wherein the context category is entity time classification, and wherein the context item is at least one of a local time, a part of day, a day of week, or special days.

In Example 74, the subject matter of any one or more of Examples 68-73 optionally include wherein the context category is inter-entity interaction, and wherein the context item is at least one of a meeting or a teleconference.

In Example 75, the subject matter of any one or more of Examples 68-74 optionally include wherein the context category is entity action, and wherein the context item is at least one of using a device or using an application on a device.

In Example 76, the subject matter of any one or more of Examples 68-75 optionally include wherein the plurality of context categories include at least two of entity location, location type, entity transit, entity time classification, inter-entity interaction, or entity action.

In Example 77, the subject matter of any one or more of Examples 66-76 optionally include wherein capturing the context of the document change event includes: querying a context item provider; and storing the context item in an entity state data structure.

In Example 78, the subject matter of Example 77 optionally includes wherein storing the context item in the entity state data structure includes: logging context item provider responses to the query; aggregating the responses to produce a state window; and storing a state with the state window.

In Example 79, the subject matter of Example 78 optionally includes wherein logging the context item includes storing a log entry that includes an entity identification, a timestamp, and an activity.

In Example 80, the subject matter of any one or more of Examples 78-79 optionally include wherein the state window includes an aggregated result from logging a response from a second context item provider for a second context category.

In Example 81, the subject matter of any one or more of Examples 77-80 optionally include wherein querying the context item provider is performed in response to receiving the document change event.

In Example 82, the subject matter of Example 81 optionally includes wherein storing the context item in the entity data structure includes creating a tag for the document including the entity state data structure, the tag being the index.

In Example 83, the subject matter of any one or more of Examples 66-82 optionally include wherein the operations further comprise: receiving a context query for the document; parsing the context query to obtain an index element; and locating the document via the index using the index element.

In Example 84, the subject matter of Example 83 optionally includes wherein parsing the context query includes: obtaining a context category definition; scanning the context query for an element satisfying the context category definition; and creating the index element from each item found during the scanning.

In Example 85, the subject matter of Example 84 optionally includes wherein the index element is a window corresponding to an entity state matching each item found during the scanning.

In Example 86, the subject matter of Example 85 optionally includes wherein locating the document via the index using the index element includes: searching for documents with a modification timestamp within the window; and returning results of the searching.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for context enhanced indexing, the system comprising:
an event listener to obtain a document change event;
a sensor to capture a context of the document change event, the context pertaining to an entity responsible for the document change event; and
a data store to store an index to correlate a context element of the context to a document of the document change event.

2. The system of claim 1, wherein, to capture the context of the document change event, the sensor is to:
query a context item provider; and
store the context item in an entity state data structure.

3. The system of claim 2, wherein, to store the context item in the entity state data structure, the data store is to:
log context item provider responses to the query;
aggregate the responses to produce a state window; and
store a state with the state window.

4. The system of claim 3, wherein the state window includes an aggregated result from logging a response from a second context item provider for a second context category.

5. The system of claim 1, comprising a search engine to:
receive a context query for the document;
parse the context query to obtain an index element; and
locate the document via the index using the index element.

6. The system of claim 5, wherein, to parse the context query, the search engine is to:
obtain a context category definition;
scan the context query for an element satisfying the context category definition; and
create the index element from each item found during the scanning.

7. The system of claim 6, wherein the index element is a window corresponding to an entity state matching each item found during the scanning.

8. The system of claim 7, wherein, to locate the document via the index using the index element, the search engine is to:
search for documents with a modification timestamp within the window; and
return results of the searching.

9. A method for context enhanced indexing, the method comprising:
obtaining a document change event;
capturing a context of the document change event, the context pertaining to an entity responsible for the document change event; and
storing an index to correlate a context element of the context to a document of the document change event.

10. The method of claim 9, wherein capturing the context of the document change event includes:
querying a context item provider; and
storing the context item in an entity state data structure.

11. The method of claim 10, wherein storing the context item in the entity state data structure includes:
logging context item provider responses to the query;
aggregating the responses to produce a state window; and
storing a state with the state window.

12. The method of claim 11, wherein the state window includes an aggregated result from logging a response from a second context item provider for a second context category.

13. The method of claim 9, comprising:
receiving a context query for the document;
parsing the context query to obtain an index element; and
locating the document via the index using the index element.

14. The method of claim 13, wherein parsing the context query includes:
obtaining a context category definition;
scanning the context query for an element satisfying the context category definition; and
creating the index element from each item found during the scanning.

15. The method of claim 14, wherein the index element is a window corresponding to an entity state matching each item found during the scanning.

16. The method of claim 15, wherein locating the document via the index using the index element includes:
searching for documents with a modification timestamp within the window; and
returning results of the searching.

17. At least one machine readable medium including instructions for context enhanced indexing, the instructions, when executed by a machine, cause the machine to perform operations comprising:
obtaining a document change event;
capturing a context of the document change event, the context pertaining to an entity responsible for the document change event; and
storing an index to correlate a context element of the context to a document of the document change event.

18. The at least one machine readable medium of claim 17, wherein capturing the context of the document change event includes:
querying a context item provider; and
storing the context item in an entity state data structure.

19. The at least one machine readable medium of claim 18, wherein storing the context item in the entity state data structure includes:
logging context item provider responses to the query;
aggregating the responses to produce a state window; and
storing a state with the state window.

20. The at least one machine readable medium of claim 19, wherein the state window includes an aggregated result from logging a response from a second context item provider for a second context category.

21. The at least one machine readable medium of claim 17, wherein the operations further comprise:
receiving a context query for the document;
parsing the context query to obtain an index element; and
locating the document via the index using the index element.

22. The at least one machine readable medium of claim 21, wherein parsing the context query includes:
obtaining a context category definition;
scanning the context query for an element satisfying the context category definition; and
creating the index element from each item found during the scanning.

23. The at least one machine readable medium of claim 22, wherein the index element is a window corresponding to an entity state matching each item found during the scanning.

24. The at least one machine readable medium of claim 23, wherein locating the document via the index using the index element includes:
searching for documents with a modification timestamp within the window; and
returning results of the searching.
